(19) United States
(12) Patent Application Publication
(10) Pub. No.: US 2016/0349562 A1
(43) Pub. Date: Dec. 1, 2016

(54) LIQUID CRYSTAL DISPLAY DEVICE AND THREE-DIMENSIONAL IMAGE DISPLAY DEVICE

(71) Applicant: Japan Display Inc., Minato-ku (JP)

(72) Inventor: Satoshi HASHIMOTO, Minato-ku (JP)

(73) Assignee: Japan Display Inc., Minato-ku (JP)

(21) Appl. No.: 15/160,472

(22) Filed: May 20, 2016

(30) Foreign Application Priority Data
Jun. 1, 2015 (JP) 2015-111325

(51) Int. Cl. G02F 1/1339; G02F 1/137; G02B 27/22; G02F 1/29; G02F 1/1368; G02F 1/1343

(52) U.S. Cl. CPC G02F 1/13394; G02F 1/1368; G02F 1/134309; G02B 27/2214; G02F 1/29; G02F 1/137; G02F 2201/123; G02F 2001/13398; G02F 2001/13396

(57) ABSTRACT

Prevention of air bubbles from forming when a LCD device is applied with external impact at low temperatures. A LCD device including a counter substrate facing a TFT substrate having matrix-arranged pixels each having a pixel electrode and a TFT, and a liquid crystal held between the TFT substrate and the counter substrate. An organic-material-made overcoat film is formed on the counter substrate. A transparent-conductive-film common electrode is formed on the overcoat film. On the counter substrate first columnar spacers in contact with the TFT substrate and second columnar spacers out of contact with the TFT substrate are formed. A common-electrode hole pattern is formed in an area corresponding to the first columnar spacers. The first columnar spacers are formed on the overcoat film, whereas the second columnar spacers are formed on the common electrode.

### CLAIM OF PRIORITY

The present application claims priority from Japanese Patent Application JP 2015-111325 filed on Jun. 1, 2015, the content of which is hereby incorporated by reference into this application.

### BACKGROUND OF THE INVENTION

### (1) Field of the Invention

The present invention relates to a liquid crystal display device, and more particularly, to a liquid crystal display device making air bubbles less liable to occur even at low temperatures.

(2) Description of the Related Art

Generally, LCD (Liquid Crystal Display) devices include a TFT substrate on which pixel electrodes, TFTs (Thin Film Transistor) and/or the like are arranged in a matrix of rows and columns, a counter substrate placed opposite the TFT substrate, and a liquid crystal held between the TFT substrate and the counter substrate. Transmittance of light through liquid crystal molecules is controlled for each pixel to form an image.

In many cases, the spacing between the TFT substrate and the counter substrate is defined by columnar spacers formed on the counter substrate. The columnar spacers are formed of transparent organic materials. Less adhesion between a columnar spacer and a base film may give rise to a phenomenon in which the columnar spacer may be peeled off during the rubbing process for the alignment film and/or the like after the columnar spacers have been formed.

If the base film for the columnar spacers is made of ITO and an adhesive strength between ITO and the columnar spacer is insufficient, the columnar spacer must be prevented from moving away from ITO. For this prevention, a technique for removing ITO from an area where the columnar spacer is to be formed is disclosed in, for example, Japanese Patent Application Laid-Open No. 2007-233059 and Japanese Patent Application Laid-Open No. 2004-333832.

The liquid crystal in the LCD device contracts in low temperature environment. In contrast, the columnar spacer has a lower thermal expansion coefficient than the liquid crystal, so that the columnar spacer has a smaller contraction factor at low temperatures than the liquid crystal. As a result, in the low temperature environment, voids will easily occur within the LCD device.

In such an event, if an external impact is applied to the LCD device, the repulsive force of the columnar spacer causes air bubbles to be formed within the LCD device. The air bubbles lead to image defects. An object of the present invention is to prevent air bubbles from occurring when an impact is applied to an LCD panel at low temperatures.

### SUMMARY OF THE INVENTION

To attain this object, the following measures are representatively provided in aspects of the present invention.

(1) An LCD device includes a TFT substrate having matrix-arranged pixels each having a pixel electrode and a TFT, a counter substrate facing the TFT substrate, and a liquid crystal held between the TFT substrate and the counter substrate. An overcoat film made of organic material is formed on the counter substrate. A transparent-conductive-film common electrode is formed on the overcoat film. On the counter substrate, first columnar spacers and second columnar spacers are formed. The first columnar spacers are in contact with the TFT substrate, whereas the second columnar spacers being out of contact with the TFT substrate. A common-electrode hole pattern is formed in an area in which the first columnar spacers are formed. The first columnar spacers are formed on the overcoat film in the common-electrode hole pattern, whereas the second columnar spacers are formed on the common electrode.

(2) In the LCD device described in the above aspect 1, preferably, the first spacer is trapezoidal in section; and when h1 is a height of the trapezoidal shape and h2 is given by h1×0.95, a top base diameter d1 of the trapezoidal shape is measured at the height h2, and when d3 is a diameter of the region created by removing the portion of the transparent conductive film, 1.04×d1≦d3 is held.

(3) In the LCD device described the above aspect (2), preferably, when d2 is a bottom base diameter of the trapezoidal shape, 1.04×d1≦d3≦d2 is held.

(4) A 3D image display device includes a liquid crystal parallax barrier panel placed on a display device. In the liquid crystal parallax barrier panel, a second substrate is placed opposite to a first substrate which has a first electrode made up of stripe-shaped electrodes arranged at predetermined pitches. A liquid crystal is held between the first substrate and the second substrate. On the second substrate, an overcoat film made of organic material is formed. In turn, a planar-shaped second electrode formed of a transparent conductive film is formed on the overcoat film. First columnar spacers and second columnar spacers are formed on the second substrate. The first columnar spacers are in contact with the first substrate and the second columnar spacers are out of contact with the first substrate. A hole pattern of the second electrode is formed in an area where the first columnar spacers are formed. The first columnar spacers are formed on the overcoat film in the hole patters of the second electrode. The second columnar spacers are formed on the second electrode.

### BRIEF DESCRIPTION OF THE DRAWINGS

FIG. 1 is a plan view of a LCD device;

FIG. 2 is a sectional view of the LCD device;

FIG. 3 is a sectional view of a counter substrate to which the present invention is not applied;

FIG. 4 is a sectional view of a counter substrate in accordance with a first embodiment of the present invention;

FIG. 5 is a sectional view illustrating an area around a columnar spacer in accordance with an embodiment of the present invention;

FIG. 6 is a plan view illustrating an area around the columnar spacer in accordance with an embodiment of the present invention;

FIG. 7 is a plan view illustrating an area around a columnar spacer of another example in accordance with an embodiment of the present invention;

FIG. 8 is a plan view illustrating an area around a columnar spacer of still another example in accordance with an embodiment of the present invention;

FIG. 9 is a sectional view of a counter substrate in accordance with a second embodiment of the present invention;

FIG. 10 is a sectional view of a counter substrate in accordance with another example of the second embodiment of the present invention;

FIG. 11 is a sectional view of a three dimensional image display device;

FIG. 12 is an explanatory schematic diagram illustrating a three dimensional image display device of a parallax-barrier type;

FIGS. 13A and 13B are sectional views illustrating the principle of a liquid crystal parallax barrier panel.

FIG. 14 is a sectional view of a common substrate of a liquid crystal parallax barrier panel in accordance with an embodiment of the present invention;

FIG. 15 is a sectional view illustrating an area of the columnar spacer in FIG. 14;

FIGS. 16A and 16B are sectional views illustrating the principle of a liquid crystal lens; and

FIG. 17 is a plan view illustrating a display device in accordance with a fourth embodiment of the present invention.

### DETAILED DESCRIPTION OF THE PREFERRED EMBODIMENTS

The present invention will be described in detail in reference to the following embodiments.

### First Embodiment

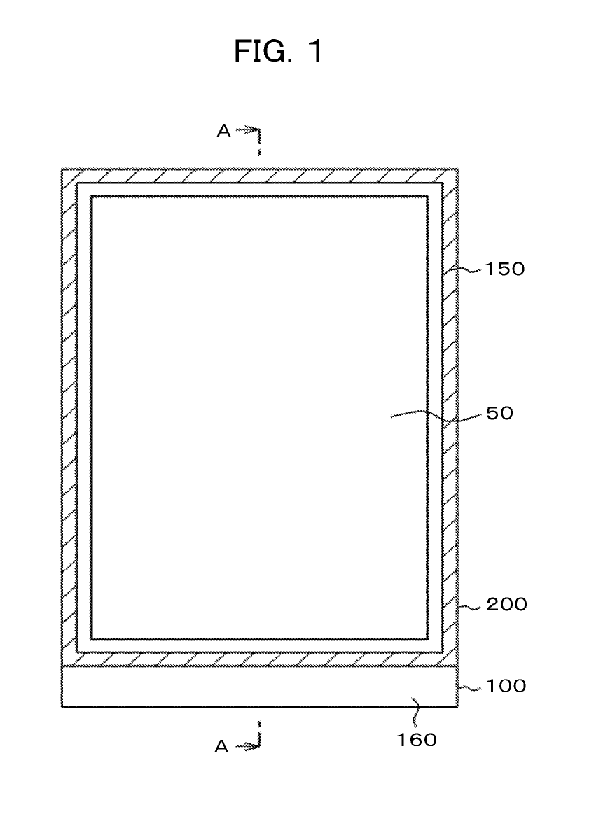

FIG. 1 is a plan view illustrating an example of an LCD device to which the present invention is applied. Referring to FIG. 1, a counter substrate 200 is placed over a TFT substrate 100. The TFT substrate 100 and the counter substrate 200 are bonded by a seal material 150 formed on the periphery. A display region 50 is formed in an area where the TFT substrate 100 and the counter substrate 200 overlap each other.

The TFT substrate 100 is formed in a size larger than the counter substrate 200. A single-layer portion of the TFT substrate 100 which does not overlap the counter substrate 200 is designed as a terminal zone 160 to which an IC driver for driving the liquid crystal and a flexible wiring substrate for supplying a power source and signals to the LCD device are connected.

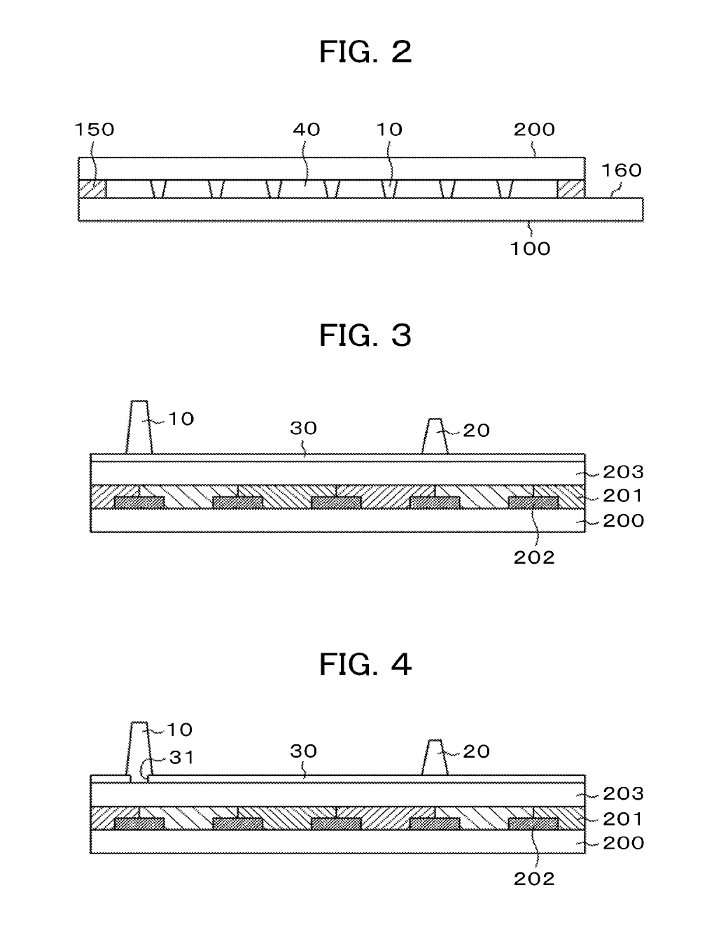

FIG. 2 is a sectional view of the LCD device taken along A-A line in FIG. 1. In FIG. 2, the TFT substrate 100 and the counter substrate 200 are bonded with the peripheral seal material 150 such that liquid crystal 40 is confined to the inside. The spacing between the TFT substrate 100 and the counter substrate 200 is maintained by columnar spacers 10 formed on the counter substrate 200.

FIG. 3 is a sectional view sowing in detail the counter substrate 200. In FIG. 3, color filters 201 are formed on the counter substrate 200. A black matrix 202 is formed between the color filter 201 and the color filer 201. The color filters 201 are covered with an overcoat film 203 which acts as preventing the liquid crystal from becoming polluted with impurities in the color filters 202.

In FIG. 3, a common electrode 30, which is made of ITO (Indium Tin Oxide) and is a transparent conductive film, is formed on the overcoat film 203. FIG. 3 illustrates the type in which the common electrode 30 is formed on the counter substrate 200, such as TN (Twisted Nematic) mode, VA (Vertical Alignment) mode and the like.

FIG. 3 illustrates a main columnar spacer 10 and a sub columnar spacer 20 that are formed as the columnar spacers. In normal condition, the main columnar spacers 10 define the spacing between the TFT substrate 100 and the counter substrate 200. In normal condition, the sub columnar spacers 20 are out of contact with the TFT substrate 100. The sub columnar spacers 20 are provided for, in LCD devices having a touch panel function, preventing an excessive decrease of the spacing between the TFT substrate 100 and the counter substrate 200 at the time when the counter substrate 200 is pressed with a finger or the like. Each of the main columnar spacers 10 has a bearing on the occurrence of air bubbles caused by low-temperature impact described below. Therefore, unless otherwise specified, words “the columnar spacer” refers to “the main columnar spacer 10”.

Note that the LCD device has an alignment film formed on each of the liquid-crystal-facing surfaces of the TFT substrate 100 and the counter substrate 200 for initial orientation of liquid crystal molecules. For the sake of brevity, the alignment film is omitted in FIG. 3. The same holds true for the other drawings.

As the temperature of the LCD device shown in FIG. 2 becomes low, the liquid crystal in the LCD device contracts. However, under normal condition, the atmosphere presses the TFT substrate 100 or the counter substrate 200, so that air bubbles are not formed within the LCD device. However, upon application of an impact to the LCD device, a large repulsive force by the columnar spacer 10 causes air bubbles to occur within the LCD device.

When an impact is applied to the LCD device, if the columnar spacer 10 is also moved or deformed by the impact to decrease the spacing between the substrates, then air bubbles are less liable to develop. However, as shown in FIG. 3, since ITO forming the common electrode 30 serving as the base of the columnar spacer 10 is firm materials, when an external impact is applied to the LCD device shown in FIG. 2, the columnar spacer 10 does not easily move, causing air bubbles to tend to occur.

FIG. 4 is a sectional view of the counter substrate 200 of the LCD device in accordance with an embodiment of the present invention. A feature in FIG. 4 is that a common-electrode hole pattern 31 is formed in an area in which the main columnar spacers 10 are formed. In contrast, the perimeter of each main columnar spacer 10 is formed on the common electrode 30. However, a major portion of the main columnar spacer 10 is formed on the overcoat film 203.

The overcoat film 203 is pliable because it is made of organic materials such as acrylic. Therefore, upon application of external impact to the LCD device, the overcoat film 203 deforms flexibly, so that the spacing between the TFT substrate 100 and the counter substrate 200 is adjusted flexibly, leading to the prevention of occurrence of air bubbles within the LCD device.

In FIG. 4, there is no common-electrode hole pattern for the sub columnar spacers 20. This is because the sub columnar spacers 20 are out of contact with the TFT substrate in normal condition, thus having no bearing on the occurrence of air bubbles in the LCD device.

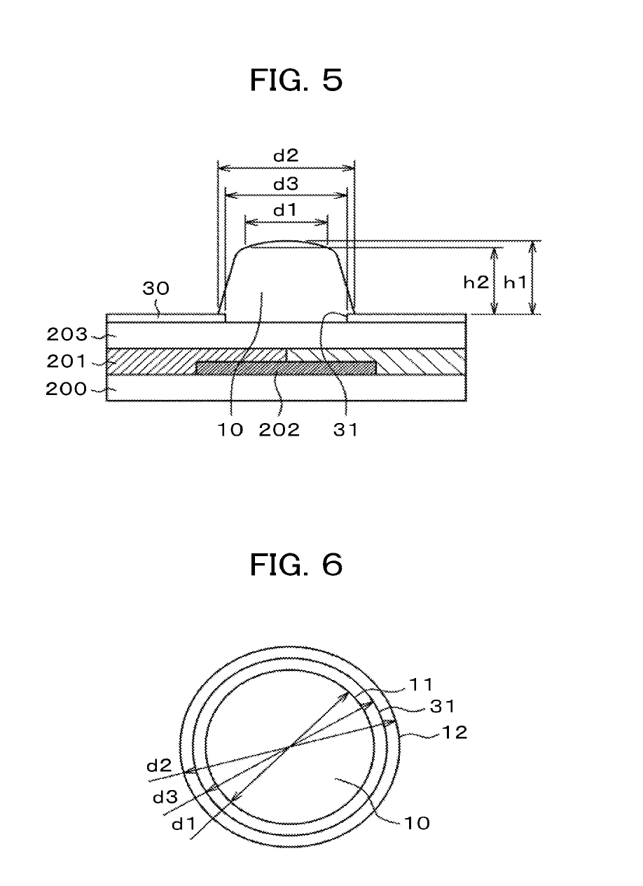

FIG. 5 is a sectional view illustrating in detail an area around the main columnar spacer 10. In FIG. 5, the color filters 201 are formed on the counter substrate 100, and the black matrix 202 is formed between adjacent color filters 201 which have different colors. The overcoat film 203 is formed to cover the color filters 201. The common electrode 30 is formed on the overcoat film 203. The common electrode 30 is made of ITO. The common-electrode hole pattern 31 is formed in an area corresponding to the black matrix 202, and in turn the columnar spacers 10 are formed on the common-electrode hole pattern 31.

In FIG. 5, parameter h1 denotes a height from the top surface of the common electrode 30 to the highest point of the columnar spacer 10. Another parameter h2 representing a height of the columnar spacer 10 is defined as 95% of the height h1. In FIG. 5, the columnar spacer 10 is trapezoidal in section and the bottom base diameter is defined by d2. The top base diameter d1 is defined as a diameter at the height h2 of the columnar spacer 10. A hole diameter of the common-electrode hole pattern 31 is defined by d3.

FIG. 5 shows the columnar spacer 10 being out of contact with the TFT substrate 100. After assembling the TFT substrate 100 and the counter substrate 200, the columnar spacer 10 comes into contact with the TFT substrate 100, causing the top end of the columnar spacer 10 to be slightly pressed to be deformed. As a result, the diameter of a portion of the columnar spacer in contact with the TFT substrate becomes d1×1.04.

As an example of dimensions of the columnar spacer 10 in FIG. 5, the height h1 ranges from 3 μm to 4 μm and thus the height h2 which is 95 percent of h1 ranges 2.85 μm to 3.8 μm. The top base diameter d1 ranges 8 μm to 23 μm, and the bottom base diameter d2 ranges 13 μm to 23 μm. In most cases, the bottom base diameter d2 is approximately equal to the top base diameter d1 plus 5 μm.

In order to flexibly change the spacing between the TFT substrate 100 and the counter substrate 200 if impact is applied to the LCD device, the major portion of the columnar spacer 10 may be preferably formed on the pliant overcoat film 203. After the TFT substrate 100 and the counter substrate 200 are placed to overlap each other, the diameter of a portion of the columnar spacer 10 in contact with the TFT substrate is d1×1.04. That is, the hole diameter d3 of the common-electrode hole pattern 31 may be preferably equal to or larger than d1×1.04. This can be expressed by the following mathematical expression,

d1×1.04≦d3 (1)

Meanwhile, as the hole diameter of the common-electrode hole pattern 31 is larger, a greater width of a light shielding region provided by the black matrix 202 is required, resulting in a decrease in transmittance. To avoid this, the hole width d3 of the common-electrode hole pattern 31 is most preferably equal to or less than the bottom base diameter d2 of the columnar spacer 10. This can be expressed by the following mathematical expression,

d1×1.04≦d3≦d2 (2)

In this manner, a major portion of the columnar spacer 10 is formed on the overcoat film 203 and only a perimeter portion is formed on the common electrode 30. Because the columnar spacer 10 is formed on the pliant overcoat film 203, the spacing between the TFT substrate 100 and the counter substrate 200 is flexibly adjusted if external impact is applied to the LCD panel. Thus, with the configuration illustrated in FIG. 5, even when the LCD device is subject to impact under low-temperature environment, occurrence of air bubbles may be prevented.

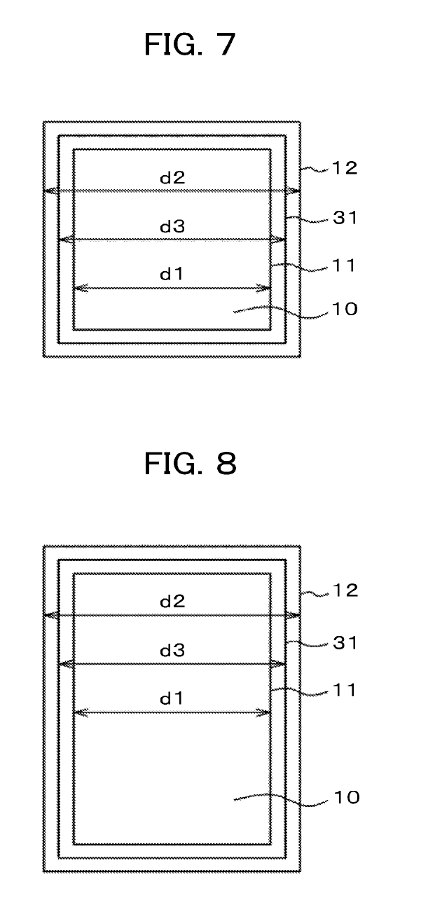

FIG. 6 to FIG. 8 are plan views illustrating examples of an area around the columnar spacer 10. FIG. 6 illustrates the columnar spacer 10 of a circular plane. In FIG. 6, reference sign 11 denotes the top base in FIG. 5, that is, the diameter at height h2, reference sign 12 denotes the bottom base in FIG. 5 and reference sign 31 denotes the common-electrode hole pattern. The same holds true for FIGS. 7 and 8. The d1, d2 and d3 in FIG. 6 are those as described in FIG. 5. FIG. 7 illustrates a columnar spacer 10 of a square plane. The d1, d2 and d3 in FIG. 7 are those as described in FIG. 5.

FIG. 8 illustrates a columnar spacer 10 of a rectangular plane, in which the diameters d1, d2 and d3 described in FIG. 5 correspond to the breadths of the rectangles. This is because, in the case of the columnar spacer 10 of the rectangular plane, using a breadth to specify d1, d2, d3 is effective.

### Second Embodiment

In a second embodiment, an example of a columnar spacer 10 placed on the TFT substrate is described. In some cases, a common electrode 30 may be formed on the TFT substrate 100, such as in IPS (In Plane Switching) mode. The content described in the first embodiment may be applied to the type of the columnar spacer 10 formed on the TFT substrate 100.

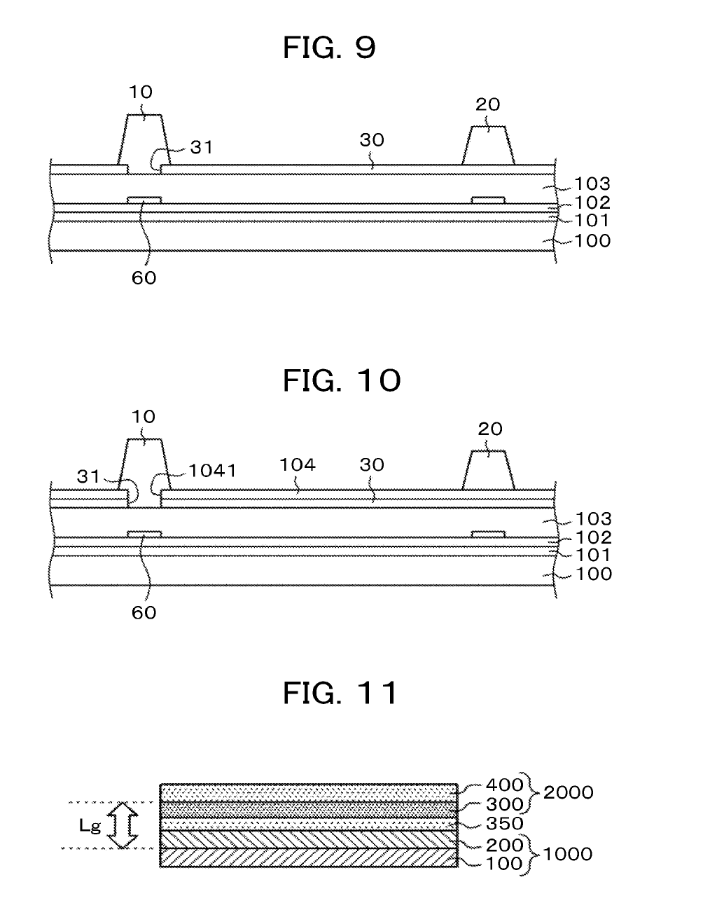

FIG. 9 is a sectional view illustrating a TFT substrate 100 where the columnar spacers 10 formed on the TFT substrate 100. In FIG. 9, the main columnar spacer 10 and the sub columnar spacer 20 are provided, and the functions of the respective columnar spacers are the same as those described in the first embodiment. Therefore, the following description is about the main columnar spacer 10.

The sectional view illustrated in FIG. 9 does not show the overall layer structure of the TFT substrate 100, which is provided for illustrative purposes only. In FIG. 9, a gate insulating film 101 is formed on the TFT substrate 100 made of glass, and in turn an interlayer insulating film 102 is formed on the gate insulating film 101. Image signal lines 60 are formed on the interlayer insulating film 102, and then an organic passivation film 103 is formed to cover the interlayer insulating film 102 and the image signal lines 60. The organic passivation film 103 is made of pliant materials such as acrylic and/or the like. The organic passivation film 103 is formed with a thickness ranging from 2 μm to 3 μm, since the film 103 also serves as a planarization film.

The common electrode 30 made of ITO is formed on the organic passivation film 103. The common-electrode hole pattern 31 is formed in an area corresponding to the image signal line 60. The columnar spacer 10 is formed on the common-electrode hole pattern 31. Since the image signal line 60 is formed of a light shielding film, forming the columnar spacer 10 in the area corresponding to the image signal line 60 leads to prevention of a reduction in transmittance.

The relationship among the bottom base diameter and the top base diameter of the columnar spacer 10, the hole diameter of the common-electrode hole pattern, and the like is similar to the case described in the first embodiment. In FIG. 9, the columnar spacer 10 is formed mainly on the organic passivation film 103. Because of this, even if impact is applied to the LCD device at low temperatures, the columnar spacer 10 adapts flexibly, enabling flexible control of the spacing between the TFT substrate 100 and the counter substrate 200. As a result, the occurrence of air bubbles can be prevented.

FIG. 10 is a sectional view illustrating another example of a TFT substrate 100 where the columnar spacers 10 are formed on the TFT substrate 100. In FIG. 10, the main columnar spacer 10 and the sub columnar spacer 20 are also provided, and the functions of the respective columnar spacers are the same as those described in the first embodiment. Therefore, the following description is about the main columnar spacer 10.

A difference of FIG. 10 from FIG. 9 is that a common electrode 30 is formed on an organic passivation film 103 on which in turn an inorganic insulating film 104 made of SiN and/or the like is formed. The inorganic insulting film 104 is also rigid as compared with the organic passivation film 103, giving rise to concern about air bubbles formed when the LCD panel is subject to external impact at low temperatures.

The relationship among the bottom base diameter and the top base diameter of the columnar spacer 10, the hole diameter of the common-electrode hole pattern, the hole diameter of the organic-passivation-film hole pattern, and the like is similar to the case described in the first embodiment. In FIG. 10, the common-electrode hole pattern 31 and the organic-passivation-film hole pattern 1041 are formed in an area of the columnar spacer 10 being formed. Because of this, a major portion of the columnar space 10 is in contact with the soft organic passivation film 103. Thus, even if external impact is applied to the LCD device, the columnar spacer 10 is able to adapt flexibly. As a result, the occurrence of air bubbles can be prevented.

### Third Embodiment

A third embodiment is an example where the present invention is applied to a parallax barrier panel for 3D display. FIG. 11 is a schematic sectional view illustrating a parallax-barrier 3D display device. In FIG. 11, a parallax barrier panel 2000 including a barrier substrate 300 and a common substrate 400 is placed on an LCD panel 1000 including a TFT substrate 100 and a counter substrate 200 through the medium of an adhesion material.

In FIG. 11, an image is formed on the inner surface of the counter substrate 200 of the LCD panel 1000. The image is divided by the barrier of the parallax barrier panel 2000 into the left-eye image and the right-eye image to generate a 3D image. The distance between the surface on which an image is formed on the LCD panel 1000 and the barrier surface of the parallax barrier panel 2000 is Lg.

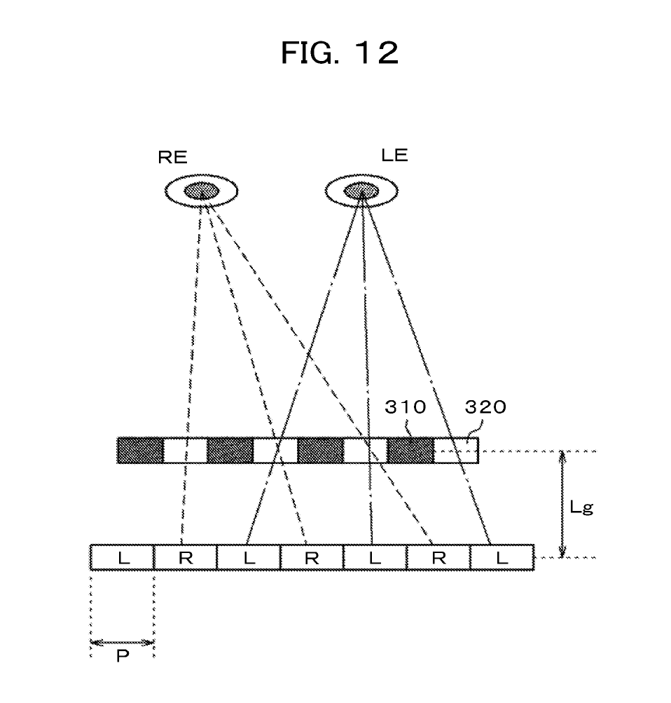

FIG. 12 is a sectional view illustrating a parallax-barrier 3D image display device. In FIG. 12, left-eye pixels L and right-eye pixels R which are formed on the LCD panel are separated by a barrier pattern formed in the parallax barrier panel, specifically, by aperture portions 320 and barrier portions 310. The pixels L and the pixels R are arranged in alternate positions with a pitch p. A left eye recognizes only the left-eye pixels L and a right eye recognizes only the right-eye pixels R, so that the viewer can recognize a 3D image.

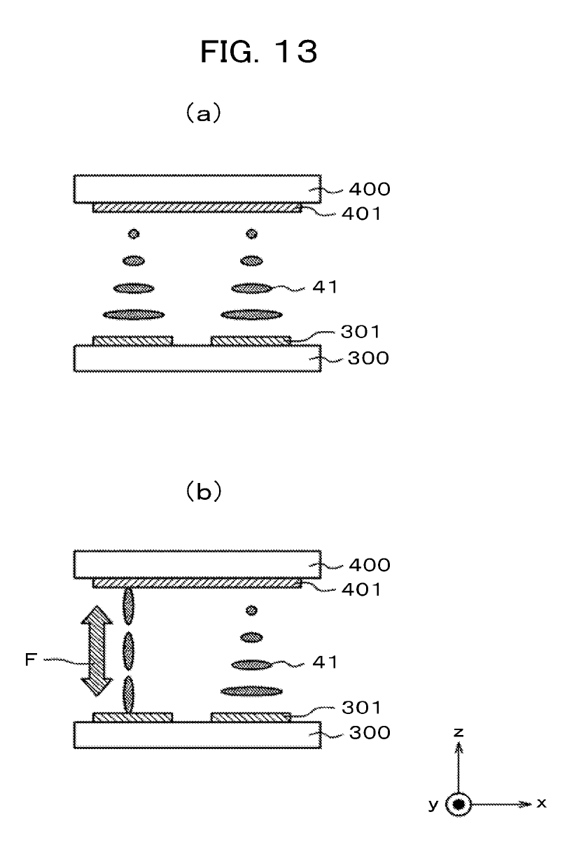

FIGS. 13A and 13B are sectional views illustrating the principles of the liquid-crystal parallax barrier panel 2000. In FIG. 13, the barrier substrate 300 has barrier electrodes 301 formed thereon in stripe form in a direction perpendicular to the drawing sheet. The common substrate 400 is placed opposite to the barrier substrate 300, and has a common electrode 401 formed thereon in a planar fashion. A TN liquid crystal is interposed between the barrier substrate 300 and the common substrate 400. That is, the liquid crystal twists 90 degrees from the barrier substrate 300 to the common substrate 400.

FIG. 13A illustrates the state in which any barrier substrate 301 is not applied with a voltage. No application of voltage to the barrier electrodes 301 effects no change in the image from the LCD panel. In this state, a 2D image is recognized.

FIG. 13B illustrates the state in which the left barrier electrode 301 is applied with a voltage. In this state, in an area corresponding to the left barrier electrode 301, the liquid crystal molecules 41 are oriented in the direction of electric field F, so that the optical activity in the liquid crystal layer is disabled to disallow light to pass through. In contrast, the optical activity is maintained in an area corresponding to the barrier electrode applied no voltage, allowing light to pass through. The barrier electrodes 301 are formed at regular intervals in strip form, resulting in the stripe-form barriers and the stripe-form apertures repeatedly appearing.

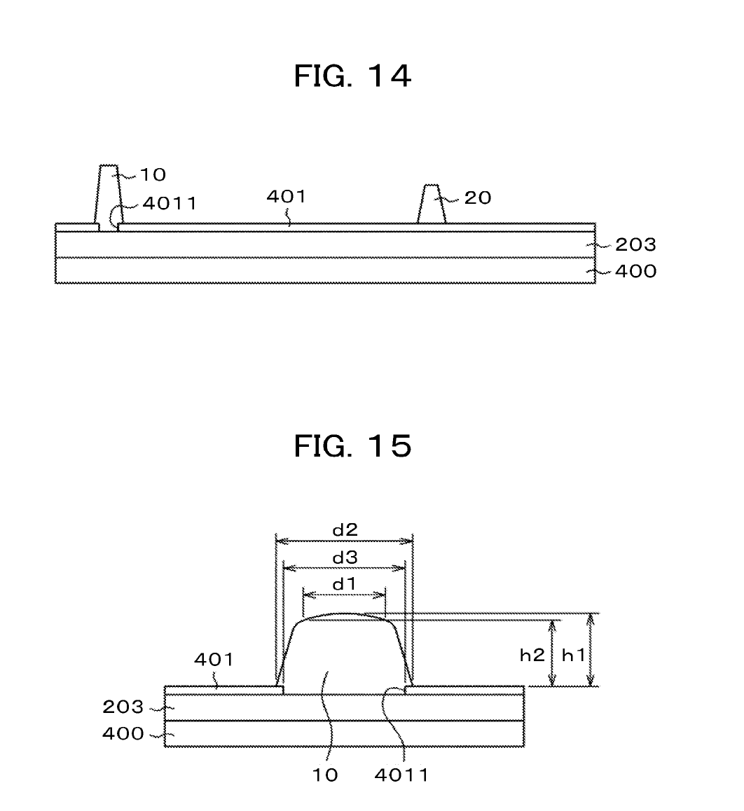

In the liquid crystal parallax barrier panel 2000, similarly, the spacing between the barrier substrate 300 and the common substrate 400 is defined by columnar spacers 10. FIG. 14 is a sectional view of the common substrate 400 on which the columnar spacers 10 are formed. In FIG. 14, an overcoat film 203 made of pliable organic materials such as acrylic and/or the like is formed on the glass common substrate 400. Then, the ITO common electrode 401 is formed in a planar fashion on the overcoat film 203.

A common-electrode hole pattern 4011 is formed in the common electrode 401, and then the main columnar spacers 10 are formed on the common-electrode hole pattern 4011. Sub columnar spacers 20 are formed as well in the liquid crystal parallax barrier panel 2000. The sub columnar spacers 20 are formed on the ITO common electrode 401.

FIG. 15 is a sectional view illustrating in detail an area around each main columnar spacer 10 (hereinafter “the columnar spacer 10”). The sectional view in FIG. 15 is similar to that in FIG. 5, with the exception that the substrate on which the columnar spacers 10 are formed is the common substrate 400. In FIG. 15, the overcoat film 203 made of pliable organic materials such as acrylic and/or the like is formed on the glass common substrate 400. In turn, the ITO common electrode 401 is formed on the overcoat film 203.

The common-electrode hole pattern 4011 is formed in the common electrode 401, and the columnar spacers 10 are formed on the common-electrode hole pattern 4011. In the section of the columnar spacer 10 illustrated in FIG. 15, the interrelationship between heights h1, h2, a top base diameter d1 and a bottom base diameter d2 of a columnar spacer and a hole diameter d3 of the common-electrode hole pattern is similar to that described in FIG. 5. Specifically, h2=0.95h1, and a preferable relationship is expressed by:

d1×1.04≦d3 (1)

and more preferably,

d1×1.04≦d3≦d2 (2)

However, absolute values of the respective dimensions differ from those in the case in FIG. 5. In most cases, a liquid crystal layer of a liquid crystal parallax barrier panel has a larger thickness than that of a LCD panel. In the liquid crystal parallax barrier panel with a thicker liquid crystal layer than that of the LCD panel, air bubbles are more likely to be formed by impact at low temperatures as compared with the case of the LCD panel. Accordingly, the present invention offers beneficial effects in the liquid crystal parallax barrier panel as well.

Methods for configuring 3D image display devices include a method using a liquid crystal lens. A 3D image display device using a liquid crystal lens is configured to include a liquid crystal lens panel in lieu of the liquid crystal parallax barrier panel in FIG. 11.

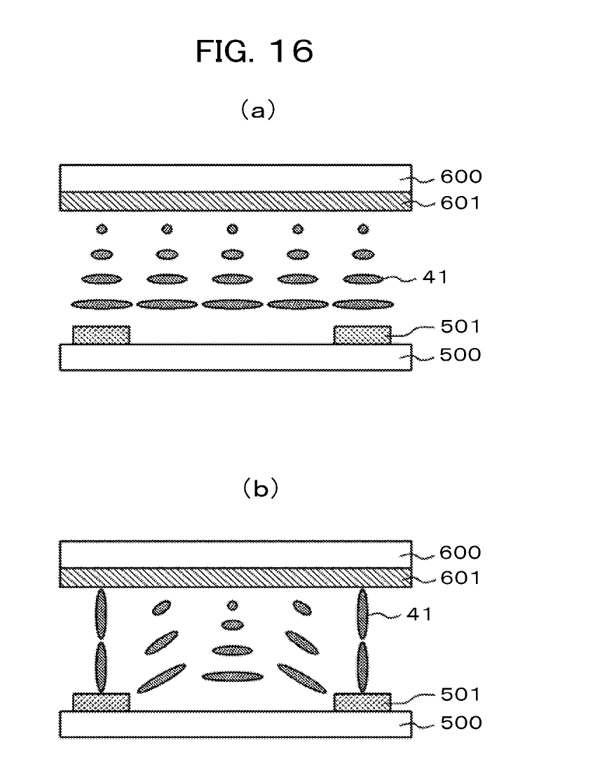

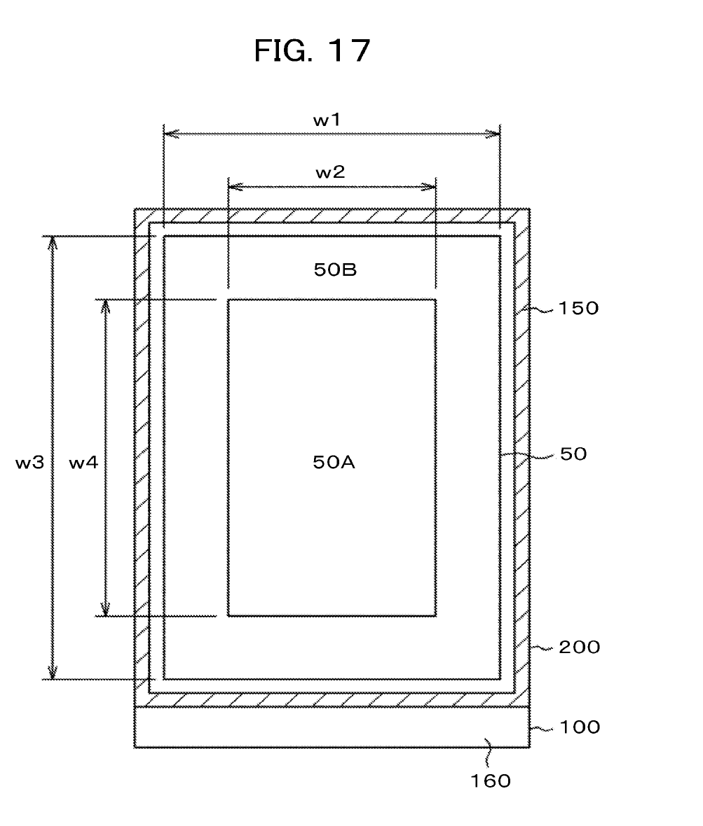

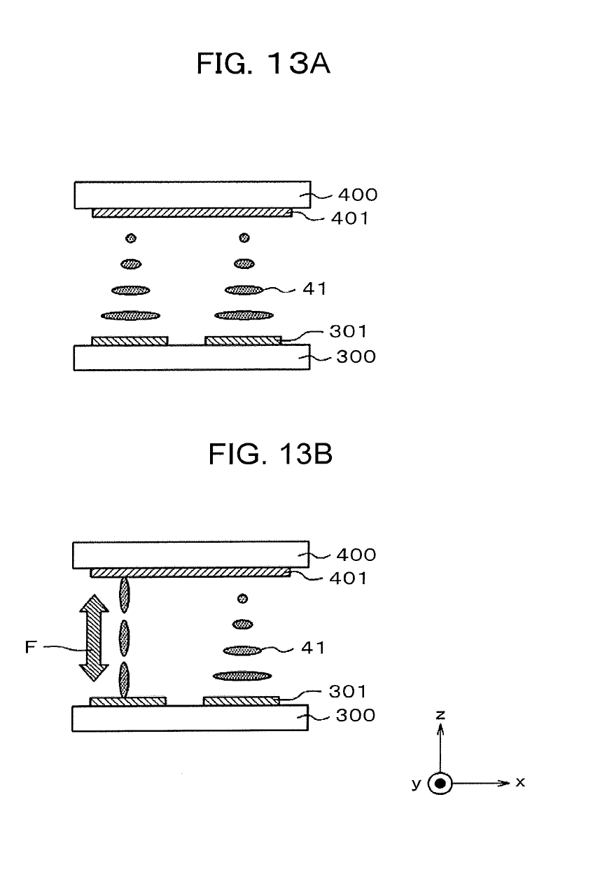

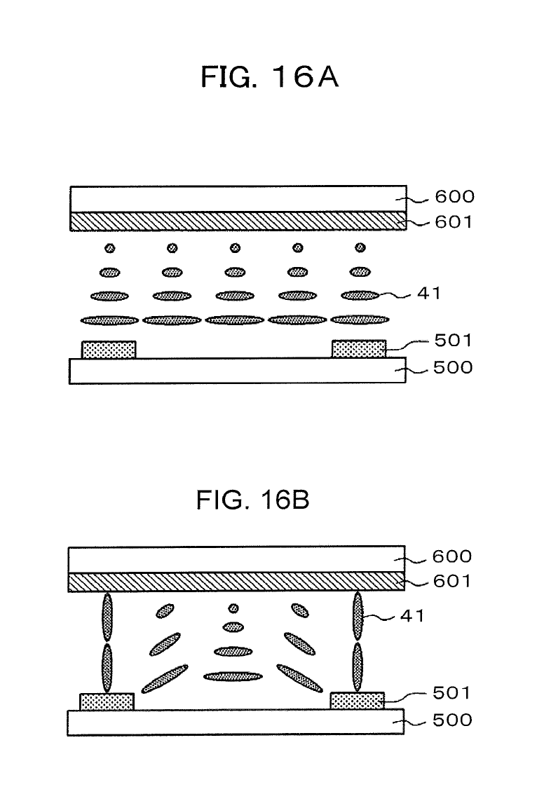

FIGS. 16A and 16B are sectional views illustrating the principles of the liquid crystal lens. The configuration of the liquid crystal lens is described with reference to FIGS. 16A and 16B. First electrodes 501 are formed on a glass-made, first substrate 500 to extend in stripe form in a direction perpendicular to the drawing sheet. A second substrate 600 made of glass is placed opposite to the first substrate 500. A second electrode 601 is formed in a planar fashion on an inner surface of the second substrate 600. A TN liquid crystal is interposed between the first substrate 500 and the second substrate 600, the liquid crystal twisting 90 degrees from the first substrate to the second substrate.

FIG. 16A illustrates the state in which a voltage is not applied to the first electrodes 501 and the second electrode 601, effecting no change in light passing through the liquid crystal lens panel. In this state, a 2D image is displayed simply.

In FIG. 16B, adjacent first electrodes 501 and the second electrode 601 are both applied with different voltages to cause the liquid crystal molecules to be oriented as shown in FIG. 16B. In an area where the first electrode 501 is opposite to the second electrode 601, the liquid crystal molecules 41 are oriented in a direction perpendicular to the substrates, disallowing light to pass through the area.

Meanwhile, in an area between the adjacent two first electrodes 501, the liquid crystal molecules 41 are oriented in different directions from position to position as illustrated in FIG. 16B. Such orientation of the liquid crystal molecules 41 effects a change in refractive index within the liquid crystal layer, forming a convex lens.

Meanwhile, on the LCD panel placed under the liquid crystal lens panel, left-eye images and right-eye images are formed to be arranged in alternate position. Then, the liquid crystal lenses are used to separate the left-eye images and the right-eye images formed on the LCD panel from each other to form a 3D image.

In FIGS. 16A and 16B, similarly, the spacing between the first substrate 500 and the second substrate 600 is defined by disposing the columnar spacers 10 on the second substrate 600 on which the planar-shaped second electrode 601 is formed. The liquid crystal lens panel also includes the second substrate of a cross section similar to that in FIG. 14. The common substrate 400 in FIG. 14 may be replaced with the second substrate 600, the common electrode 401 may be replaced with the second electrode 601, and the common-electrode hole pattern 4011 may be replaced with a second-electrode hole pattern.

According to an embodiment of the present invention, as illustrated in FIG. 14 seen with making the above replacements, an overcoat film 203 made of pliable organic materials such as acrylic and/or the like is formed on the second substrate 600, and in turn the planar-shaped second electrode 601 is formed on the overcoat film 203. Then, the hole pattern is formed in the second electrode 601 and the columnar spacers are formed on the hole pattern.

In short, a similar configuration to the common substrate of the liquid crystal parallax barrier panel described in FIG. 14 may be applied to the liquid crystal lens panel. Accordingly, the same relationship as that between the shapes of the columnar spacer 10, the hole pattern 4011 of the common electrode 401 in FIG. 14 may be applied for the shapes of the columnar spacer 10, the hole pattern of the second electrode 601 and/or the like.

The display panel placed under the liquid crystal parallax barrier panel or the liquid crystal lens panel has been described as a LCD panel, but is not limited to this and may be an organic EL display panel or any other display panels.

### Fourth Embodiment

FIG. 17 is a plan view illustrating a LCD display in accordance with a fourth embodiment. The configuration in FIG. 17 is similar to that described in FIG. 1, except for the display region 50. The display region 50 in FIG. 17 includes an inner region 50A, and a region outside the inner region 50A, that is, a region 50B provided close to the seal material 150.

A cause of forming air bubbles in the LCD device to which impact is applied at low temperatures is not provided uniformly throughout the entire display region. In FIG. 17, in the region 50B located close to a perimeter portion around which the seal material 150 is formed, the seal material 150 serves as a support, making air bubbles apt to be formed. Accordingly, the present invention such as described in the first embodiment may be effectively applied to the region close to the seal material 150, namely, the region 50B in FIG. 17.

When the breadth diameter (width) of the display region 50 is w1 and the breadth diameter of the central region 50A is w2, w2/w1=0.6. When the longitudinal diameter (length) of the display region 50 is w3 and the longitudinal diameter of the central region 50A is w4, w4/w3=0.6.

In the above description, the transparent conductive film has been described as being made of ITO, but is not limited to this and may be made of AZO, IZO and/or the like. Further, using acrylic resin to form the overcoat film or organic passivation film has been described by way of example, but silicone resin, epoxy resin, polyimide resin and the like may be also used. Further, if the color filter and/or the black matrix are formed of an organic film, structure without an overcoat may be employed. Still further, the color filter may be arranged on the TFT substrate. It is noted that the black matrix need not necessarily be formed in a matrix form, but may be formed in a stripe form or the like, irrespective of the shape, as long as it is a light shielding film.

What is claimed is:

1. A liquid crystal display device including
a TFT substrate on which pixels each having a pixel electrode and a thin-film transistor are formed;
a counter substrate placed opposite to the TFT substrate; and
a liquid crystal held between the TFT substrate and the counter substrate, the liquid crystal display device, comprising:
an organic film formed on the counter substrate;
a transparent conductive film formed between the organic film and the liquid crystal; and
first spacers and second spacers formed on the counter substrate,
wherein;
a portion of the transparent conductive film is removed in an area where each of the first spacers is formed, and the first spacer is formed between the organic film and the liquid crystal in a region created by removing the portion of the transparent conductive film; and
the second spacers are formed between the transparent conductive film and the liquid crystal.

2. The liquid crystal display device according to claim 1, wherein:
the first spacer is trapezoidal in section; and
when h1 is a height of the trapezoidal shape and h2 is given by h1×0.95, a top base diameter d1 of the trapezoidal shape is measured at the height h2, and when d3 is a diameter of the region created by removing the portion of the transparent conductive film, 1.04×d1≦d3 is held.

3. The liquid crystal display device according to claim 2, wherein when d2 is a bottom base diameter of the trapezoidal shape, 1.04×d1≦d3≦d2 is held.

4. The liquid crystal display device according to claim 2, wherein a plane of the first spacer has a round shape.

5. The liquid crystal display device according to claim 2, wherein a plane of the first spacer has a square shape.

6. The liquid crystal display device according to claim 2, wherein a top face of the first spacer has a rectangular shape in a plan view, and the region created by removing the portion of the transparent conductive film is formed in a rectangular shape corresponding to the top face of the first spacer, the d1 representing a short diameter of the rectangular shape in the plan view of the top face of the first spacer, and the d3 representing a short diameter of the region created by removing the portion of the transparent conductive film and having the rectangular shape.

7. A liquid crystal display device including
a TFT substrate on which pixels having thin-film transistors are formed, an organic film is formed to cover the thin-film transistors and in turn a transparent conductive film is formed to cover the organic film;
a counter substrate placed opposite to the TFT substrate; and
a liquid crystal held between the TFT substrate and the counter substrate, the liquid crystal display device, comprising:
first spacers and second spacers formed on the TFT substrate, the first spacers being in contact with the counter substrate and the second spacers being out of contact with the counter substrate,
wherein;
a region is created by removing a portion of the transparent conductive film in an area in which each of the first spacers is formed, and the first spacer is formed on the organic film in the region created by removing the portion of the transparent conductive film; and
the second spacers are formed on the transparent conductive film.

8. The liquid crystal display device according to claim 1, wherein:
when w1 is a diameter of a display region and w2 is a diameter of a central region within the display region, w2/w1=0.6 is held; and
a set of the first spacer and the corresponding region created by removing the portion of the transparent conductive film is located outside of the central region.

9. The liquid crystal display device according to claim 2, wherein:
when w1 is a diameter of a display region and w2 is a diameter of a central region within the display region, w2/w1=0.6 is held; and
a set of the first spacer and the corresponding region created by removing the portion of the transparent conductive film is located outside of the central region.

10. A liquid crystal display device including
a TFT substrate on which pixels having TFTs are formed in a matrix arrangement, an organic passivation film is formed to cover the TFTs and in turn a inorganic insulating film is formed to cover the organic passivation film;
a counter substrate placed opposite to the TFT substrate; and
a liquid crystal held between the TFT substrate and the counter substrate, the liquid crystal display device, comprising:
first columnar spacers and second columnar spacers formed on the TFT substrate, the first columnar spacers being in contact with the counter substrate and the second columnar spacers being out of contact with the counter substrate,
wherein;
a hole pattern of the inorganic insulating film is formed in an area in which the first columnar spacers are formed, and the first columnar spacers are formed on the organic passivation film in the hole pattern of the inorganic insulating film; and
the second columnar spacers are formed on the inorganic insulating film.

11. The liquid crystal display device according to claim 10, wherein:
when w1 is a diameter of a display region and w2 is a diameter of a central region within the display region, w2/w1=0.6 is held; and
a set of the first columnar spacers and the hole pattern of the inorganic insulating film is located outside of the central region.

12. A three-dimensional image display device, comprising a display device and a liquid crystal parallax barrier panel placed on the display device, wherein:
the liquid crystal parallax barrier panel includes a first substrate having a first electrode made up of stripe-shaped electrodes arranged at predetermined pitches, a second substrate placed opposite to the first substrate, and a liquid crystal held between the first substrate and the second substrate;
on the second substrate, an organic film, and a second electrode formed of a transparent conductive film provided between the organic film and the liquid crystal are formed;
first spacers and second spacers are formed on the second substrate;
a hole pattern of the second electrode is formed in an area where the first spacers are formed, the first spacers being formed on the organic film in the hole patters of the second electrode; and
the second spacers are formed on the second electrode.

13. The three-dimensional image display device according to claim 12, wherein:
when w1 is a diameter of a display region and w2 is a diameter of a central region within the display region, w2/w1=0.6 is held; and
a set of the first columnar spacers and the hole pattern of the second electrode is located outside of the central region.

14. A three-dimensional image display device, comprising a display device and a liquid crystal lens panel placed on the display device, wherein:
the liquid crystal lens panel includes a first substrate having a first electrode made up of stripe-shaped electrodes arranged at predetermined pitches, a second substrate placed opposite to the first substrate, and a liquid crystal held between the first substrate and the second substrate;
on the second substrate, an overcoat film made of organic material, and a planar-shaped second electrode formed of a transparent conductive film is formed on the overcoat film;
first columnar spacers and second columnar spacers are formed on the second substrate, the first columnar spacers being in contact with the first substrate and the second columnar spacers being out of contact with the first substrate;
a hole pattern of the second electrode is formed in an area where the first columnar spacers are formed, the first columnar spacers being formed on the overcoat film in the hole patters of the second electrode; and
the second columnar spacers are formed on the second electrode.

15. The three-dimensional image display device according to claim 14, wherein:
when w1 is a diameter of a display region and w2 is a diameter of a central region within the display region, w2/w1=0.6 is held; and
a set of the first columnar spacers and the hole pattern of the second electrode is located outside of the central region.
